(19) United States
(12) Patent Application Publication
(10) Pub. No.: US 2017/0269394 A1
(43) Pub. Date: Sep. 21, 2017

(54) LIGHT MODULATOR AND IMAGE DISPLAY DEVICE

(71) Applicant: Seiko Epson Corporation, Tokyo (JP)

(72) Inventor: Hiroto TOMIOKA, Chino (JP)

(21) Appl. No.: 15/461,890

(22) Filed: Mar. 17, 2017

(30) Foreign Application Priority Data
Mar. 18, 2016 (JP) 2016-054952

(51) Int. Cl. G02F 1/035; H04N 9/31; G02F 1/225

(52) U.S. Cl. CPC G02F 1/035; G02F 1/2257; H04N 9/3129; G02F 2201/07; G02F 2201/063; G02F 2001/212

(57) ABSTRACT

A light modulator according to the invention includes an optical waveguide formed of a material having an electro-optic effect, a buffer layer formed on the optical waveguide, and a pair of electrodes formed on the buffer layer, the width in the direction, in which the pair of electrodes are opposed to each other, of the buffer layer located on the side of the electrodes opposed to the optical waveguide is smaller than the width in the direction, in which the pair of electrodes are opposed to each other, of the buffer layer located on the optical waveguide side.

### BACKGROUND

1. Technical Field

The present invention relates to a light modulator and an image display device.

2. Related Art

In the past, there has been known that a so-called external light modulator using an electro-optic crystal or the like is capable of far faster and wider-band light modulation compared to direct modulation of a semiconductor laser in a related art.

In JP-A-5-19220 (Document 1), there is disclosed a light modulator having optical waveguides formed in a thin film having an electro-optic effect, and a buffer layer and electrodes formed on the thin film, wherein the light modulator has a structure in which the thin film is provided with a groove.

In the light modulator of Document 1, an amount of the phase shift, which is caused between the two optical waveguides as a pair in a light source section for emitting light, is proportional to the variation in refractive index in an electro-optic crystal substrate and the length of the electrodes. Therefore, in the case of attempting to miniaturize the external light modulator, if the electrode length is shortened, it is unachievable to provide the desired amount of the phase shift in the optical waveguides, the desired change no more occurs in the intensity of the outgoing light, the difference between bright and dark in the light combined decreases, and the desired light modulation characteristic cannot be obtained. Therefore, there is a problem that the miniaturization is difficult.

### SUMMARY

An advantage of some aspects of the invention is to solve at least a part of the problems described above, and the invention can be implemented as the following forms or application examples.

### Application Example 1

A light modulator according to this application example includes an optical waveguide formed of a material having an electro-optic effect, a buffer layer formed on the optical waveguide, and a pair of electrodes formed on the buffer layer, and a width in a direction, in which the pair of electrodes are opposed to each other, of the buffer layer located on a side of the electrodes opposed to the optical waveguide is smaller than a width in the direction, in which the pair of electrodes are opposed to each other, of the buffer layer located on the optical waveguide side.

According to this application example, since the width of the buffer layer located on the electrode side opposed to the optical waveguide is smaller than the width of the buffer layer located on the optical waveguide side, it becomes possible to reduce the electric field warped around from the outer side of the electrode and exerted toward the electrode opposed, and thus, it is possible to increase the intensity of the electric field in the direction perpendicular to the optical waveguide to increase the variation in refractive index. Therefore, since the desired phase shift amount can be provided even if the electrode length is decreased, the light modulator can be miniaturized. Therefore, the light modulator small in size can be provided.

### Application Example 2

In the light modulator according to the application example described above, it is preferable that the width in the direction, in which the pair of electrodes are opposed to each other, of the buffer layer located on the side of the electrodes opposed to the optical waveguide is equal to a width in the direction, in which the pair of electrodes are opposed to each other, of the electrodes.

According to this application example, since the width in the direction in which the electrodes are opposed to each other of the buffer layer located on the electrode side opposed to the optical waveguide is equal to the width in the direction in which the electrodes are opposed to each other of the electrodes, the electric field immediately below the electrodes is concentrated in the direction perpendicular to the substrate, and thus, it is possible to increase the intensity of the electric field in the direction perpendicular to the optical waveguide to increase the variation in refractive index. Therefore, since the desired phase shift amount can be provided even if the electrode length is decreased, the light modulator can be miniaturized. Therefore, an advantage of further miniaturization of the light modulator can be obtained.

### Application Example 3

In the light modulator according to the application example described above, it is preferable that the buffer layer is provided with a groove disposed between the pair of electrodes.

According to this application example, since the buffer layer is provided with the groove disposed between the pair of electrodes, it becomes possible to reduce the electric field, which is not exerted in the direction from one of the electrodes toward the optical waveguide, but is exerted toward the other of the electrodes via the buffer layer, and thus, it is possible to increase the intensity of the electric field in the direction perpendicular to the optical waveguide, and the variation in refractive index can be increased. Therefore, even if the electrode length is decreased, the desired phase shift amount can be provided, and thus, the light modulator can be miniaturized. Therefore, the light modulator small in size can be provided.

### Application Example 4

In the light modulator according to the application example described above, it is preferable that the buffer layer is provided with a notch disposed on an opposite side to surfaces on which the electrodes are opposed to each other.

According to this application example, since the notch is disposed on the opposite side to the surfaces of the buffer layer on which the electrodes are opposed to each other, it is possible to reduce the electric field warped around from the outer side of the electrode and exerted toward the electrode opposed, and thus, it is possible to increase the intensity of the electric field in the direction perpendicular to the substrate to increase the variation in refractive index. Therefore, since the desired phase shift amount can be provided even if the electrode length is decreased, the light modulator can be miniaturized. Therefore, an advantage of further miniaturization of the light modulator can be obtained.

### Application Example 5

In the light modulator according to the application example described above, it is preferable that the buffer layer is provided with a mesa shape.

According to this application example, since the mesa shape is provided to the opposite side to the surfaces of the buffer layer on which the electrodes are opposed to each other, it is possible to reduce the electric field warped around from the outer side of the electrode and exerted toward the electrode opposed, and thus, it is possible to increase the intensity of the electric field in the direction perpendicular to the substrate to increase the variation in refractive index. Therefore, since the desired phase shift amount can be provided even if the electrode length is decreased, the light modulator can be miniaturized. Therefore, an advantage of further miniaturization of the light modulator can be obtained.

### Application Example 6

In the light modulator according to the application example described above, it is preferable that the optical waveguide is provided to a substrate, and the groove is provided to the substrate.

According to this application example, since the substrate is provided with the groove disposed between the electrodes, the electric field generated in the substrate in the horizontal direction between the electrodes is reduced, and thus, it is possible to increase the intensity of the electric field in the direction perpendicular to the substrate to increase the variation in refractive index. Therefore, since the desired phase shift amount can be provided even if the electrode length is decreased, the light modulator can be miniaturized. Therefore, an advantage of further miniaturization of the light modulator can be obtained.

### Application Example 7

In the light modulator according to the application example described above, it is preferable that the material having the electro-optic effect is lithium niobate.

According to this application example, since the material having the electro-optic effect is lithium niobate, the photoelectric coefficient in the perpendicular direction is high, and thus, it is possible to increase the electric field intensity of the optical waveguide to increase the variation in refractive index. Therefore, since the desired phase shift amount can be provided even if the electrode length is decreased, the light modulator can be miniaturized. Therefore, an advantage of further miniaturization of the light modulator can be obtained.

### Application Example 8

An image display device according to this application example includes a light source section adapted to emit a light beam, the light modulator according to any one of the application examples described above, and a light scanner adapted to perform a spatial scanning operation with light modulated by the light modulator.

According to this application example, by performing the spatial scanning operation with the light modulated using the light scanner, an image and a picture can be projected. Further by using the light modulator, there can be obtained the advantage of the miniaturization and the reduction in power consumption of the image display device.

### BRIEF DESCRIPTION OF THE DRAWINGS

The invention will be described with reference to the accompanying drawings, wherein like numbers reference like elements.

FIG. 1 is a perspective view of a light modulator according to a first embodiment of the invention.

FIG. 2 is a perspective view of an element substrate.

FIG. 3 is a cross-sectional view along the line A-A shown in FIG. 1.

FIG. 4 is a cross-sectional view of an essential part of a light modulator according to a second embodiment of the invention.

FIG. 5 is a cross-sectional view of an essential part of a light modulator according to a first modified example.

FIG. 6 is a cross-sectional view of an essential part of a light modulator according to a second modified example.

FIG. 7 is a cross-sectional view of an essential part of a light modulator according to a third modified example.

FIG. 8 is a diagram showing a schematic configuration of an image display device according to a third embodiment of the invention.

FIG. 9 is a partial enlarged view of the image display device shown in FIG. 8.

### DESCRIPTION OF EXEMPLARY EMBODIMENTS

Some embodiments of the invention will hereinafter be described with reference to the accompanying drawings. It should be noted that in each of the drawings described below, the scale sizes of the layers and the members are made different from the actual dimensions in order to make the layers and the members have recognizable dimensions.

### Light Modulator

### First Embodiment

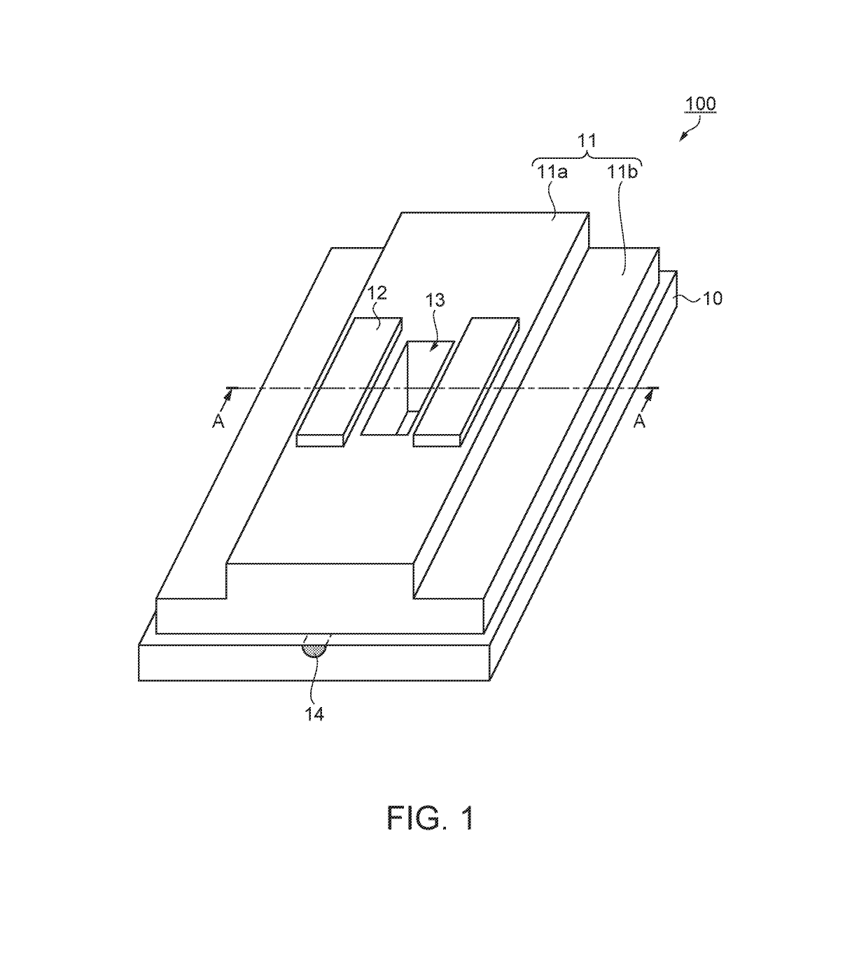

Firstly, a schematic configuration of the light modulator 100 according to a first embodiment will be described with reference to FIG. 1 through FIG. 3.

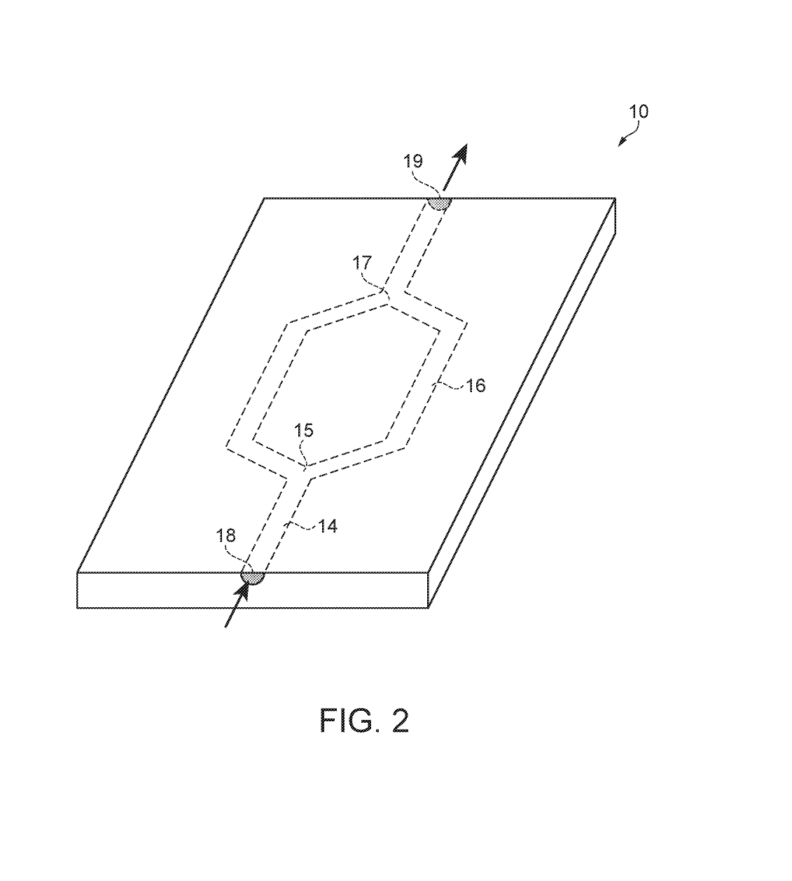

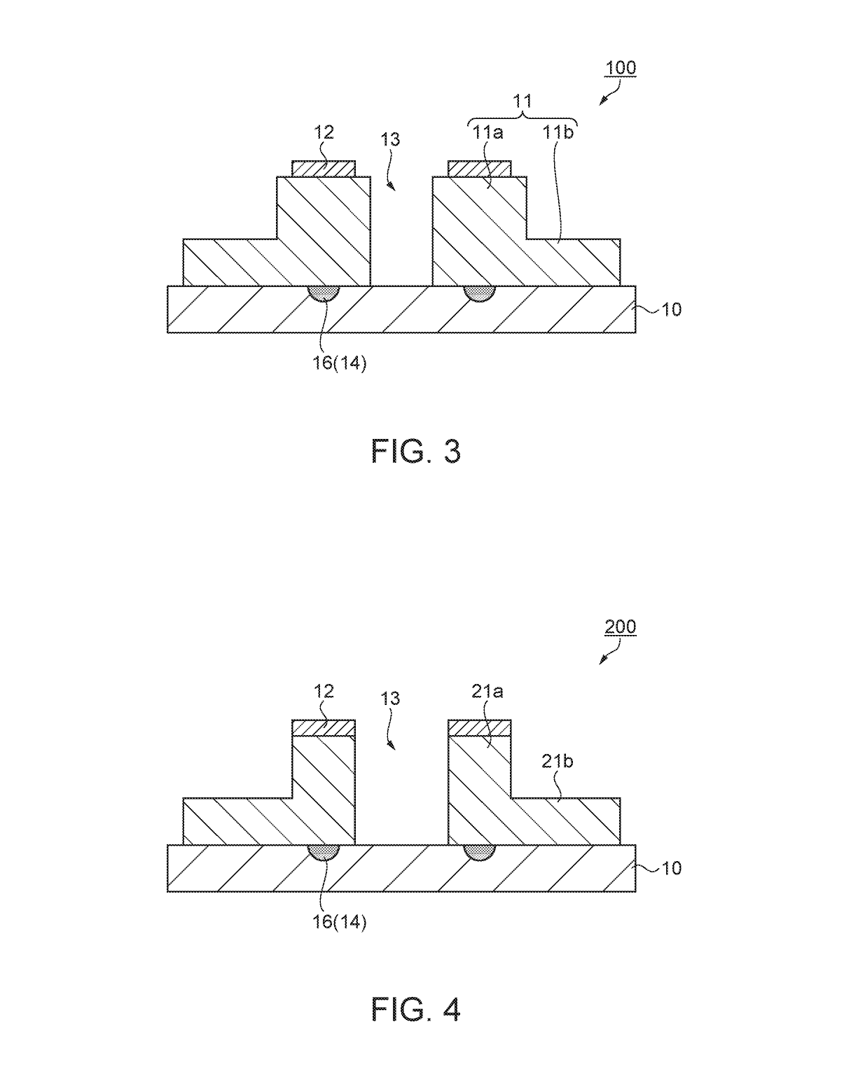

FIG. 1 is a perspective view of the light modulator 100 according to the first embodiment. FIG. 2 is a perspective view of an element substrate 10. FIG. 3 is a cross-sectional view along the line A-A shown in FIG. 1.

As shown in FIG. 1 through FIG. 3, the light modulator 100 according to the present embodiment is configured including the element substrate 10 as a substrate, a buffer layer 11, electrodes 12, a groove 13, and an optical waveguide 14 having a branch part 15, straight parts 16, and a multiplexing part 17.

The element substrate 10 is an electro-optic crystal substrate. As the electro-optic crystal, there can be cited lithium niobate, zinc telluride, lithium tantalate, KDP crystal, BBO crystal, and so on. Among these substances, lithium niobate is particularly preferably used. Since lithium niobate is relatively high in electro-optic coefficient, when selecting the wavelength of the light to be transmitted, it is possible to lower the drive voltage, and to shorten the working distance, and further, when modulating the intensity of the light, it is possible to lower the drive voltage, and to shorten the working distance. Therefore, it is possible to reduce the power consumption of the light modulator 100.

The buffer layer 11 is constituted by two areas, namely a buffer layer 11a located on the side having contact with the electrodes 12, and a buffer layer 11b located on the side having contact with the element substrate 10, and is a layer for preventing a propagation loss of a light wave caused by the electrodes 12. For the buffer layer 11, there is selected a material lower in refractive index than the element substrate 10. In this case, silicon dioxide or the like is used. The thickness is desirably no smaller than 10 μm and no larger than 1 mm. The buffer layer 11 is formed on the element substrate 10 using, for example, a sputtering method.

The buffer layer 11 is formed to have a stepped shape using a usual measure such as photolithography or argon ion etching so that the width (the width in a direction in which the pair of electrodes 12 are opposed to each other) of the buffer layer 11a on the side having contact with the electrodes 12 is smaller than the width (the length in the direction crossing the longitudinal direction of the element substrate 10) of the buffer layer 11b located on the side having contact with the element substrate 10. The width of the buffer layer 11a is desirably no smaller than 10 nm and no larger than 100 μm. The thickness of the buffer layer 11a is desirably no smaller than 10 μm and no larger than 1 mm.

For the electrodes 12, there is used metal such as aluminum, copper, gold, chromium, iron, or platinum, or an alloy. The thickness is desirably no smaller than 10 nm and no larger than 10 μm. The pair of electrodes 12 are deposited and patterned on the buffer layer 11a using a usual measure such as vacuum evaporation, photolithography, or dry etching. The distance between the pair of electrodes 12 is desirably no smaller than 10 nm and no larger than 100 μm. Further, the width of each of the electrodes 12 is desirably no smaller than 10 nm and no larger than 100 μm.

The groove 13 is formed between the pair of electrodes 12 in the buffer layer 11 using a usual measure such as photolithography or argon ion etching. The width of the groove 13 is desirably no smaller than 10 nm and no larger than 100 μm. The depth 13 is desirably no smaller than 10 nm and no larger than 1 mm.

The optical waveguide 14 is a light guide path formed in the element substrate 10. As a method of forming the optical waveguide 14 in the element substrate 10, there can be cited, for example, a proton-exchange method and a Ti diffusion method.

The optical waveguide 14 constitutes a Mach-Zehnder interferometer, and when making the incident light 18 enter the optical waveguide 14 from one end, the incident light 18 is guided to the branch part 15 to generate a phase difference between the light waves in both of the optical waveguides in the straight parts 16. In that case, interference occurs in the multiplexing part 17, and variation in light intensity corresponding to the phase difference occurring in the straight parts 16 is generated in the outgoing light 19. The width of the optical waveguide 14 is desirably no smaller than 10 nm and no larger than 100 μm. The distance between the straight parts 16 is desirably no smaller than 10 nm and no larger than 100 μm.

Further, the optical waveguide 14 can be provided to a thin film or the like having an electro-optic effect.

Then, the principle of the light modulation by the light modulator 100 will be described.

In the case of performing the modulation using the light modulator 100, a signal source for supplying a modulation signal is connected to an end and of either one of the branch part 15 side and the multiplexing part 17 side of the electrodes 12, a termination resistor for suppressing the reflection of the modulated wave is connected to the other end on the opposite side to the end to which the signal source is connected, and then a voltage is applied between the pair of electrodes 12. When a signal voltage is applied to the electrodes 12, electric fields in respective directions vertically opposite to each other are applied to the respective straight parts 16 of the optical waveguide 14 located immediately below the electrodes 12.

On this occasion, the refractive index in the straight parts 16 of the optical waveguide 14 changes reversely in proportion to the intensity of the electric fields due to the electro-optic effect. In the case of using a Z-cut electro-optic crystal substrate, the intensity of the electric field component in a direction perpendicular to the substrate determines the variation of the refractive index. Since the electric fields in the respective directions vertically opposite to each other are applied to the straight parts 16, in the pair of straight parts 16, variations in refractive index reverse in polarity from each other are generated, and therefore the refractive index difference occurs.

A phase difference of the light waves in the multiplexing part 17 occurs in proportion to the refractive index difference in the pair of straight parts 16 caused by the principle described above and the length of the straight parts 16. Since the light waves, which pass through the pair of straight parts 16, and in which the phase difference occurs, are added to each other in the multiplexing part 17, the intensity of the outgoing light 19 varies.

Therefore, in the case of miniaturizing the light modulator 100, since the length of the straight parts 16 decreases, the desired phase difference does not occur in the multiplexing part 17. Therefore, it becomes a problem that the desired intensity variation becomes unable to be obtained in the outgoing light 19, and thus the difference between bright and dark becomes small.

Therefore, according to the light modulator 100 related to the present embodiment, the following advantages can be obtained.

In the light modulator 100 according to the present embodiment, since the width of the buffer layer 11a on the side having contact with the electrodes 12 is made narrower, it becomes possible to reduce the electric field warped around from the outer side of the electrodes 12 and proceeding toward the electrodes 12 opposed to each other out of the vector components of the electric field generated in the buffer layer 11.

In other words, the component of the electric field in a direction parallel to the element substrate 10 is suppressed, and the electric field in a direction perpendicular to the element substrate 10 is strengthened. Since the electric field limited to the perpendicular direction reaches the element substrate 10, the variation of the refractive index increases, and even if the length of the straight parts 16 is decreased, the desired phase shift amount can be provided to the light waves in the multiplexing part 17. Therefore, the light modulator 100 can be miniaturized. Therefore, an advantage of further miniaturization of the light modulator 100 can be obtained.

Further, since the groove 13 is disposed between the pair of electrodes 12 on the buffer layer 11, it becomes possible to reduce the electric field, which is not exerted in the direction from one of the electrodes 12 toward the optical waveguide 14 but is exerted toward the other of the electrodes 12 via the buffer layer 11, and thus, it is possible to increase the intensity of the electric field in the direction perpendicular to the optical waveguide 14, and the variation in refractive index can be increased. Therefore, even if the electrode length is decreased, the desired phase shift amount can be provided, and thus, the light modulator 100 can be miniaturized. Therefore, the light modulator 100 small in size can be provided.

### Second Embodiment

Then, a configuration of a light modulator 200 according to a second embodiment will be described with reference to FIG. 4.

FIG. 4 is a cross-sectional view of an essential part of the light modulator 200 according to the second embodiment.

The light modulator 200 according to the present embodiment has a structure in which the width of the buffer layer 21a on the side having contact with the electrode 12 is equal to the width of the electrode 12.

Therefore, according to the light modulator 200 related to the present embodiment, the following advantages can be obtained in addition to the advantages in the first embodiment.

Due to the configuration in which the width of the buffer layer 21a is equal to the width of the electrode 12, the electric field component in the buffer layer 21a exerted in an outward direction is further suppressed compared to the light modulator 100 according to the first embodiment. Therefore, since the electric field limited to the perpendicular direction reaches the element substrate 10, the variation of the refractive index becomes greater than that of the light modulator 100 according to the first embodiment, and even if the length of the straight parts 16 is decreased, the desired phase shift amount can be provided to the light waves in the multiplexing part 17. Therefore, the light modulator 100 can further be miniaturized.

It should be noted that the invention is not limited to the embodiments described above, but various modifications or improvements can be provided to the embodiments described above. Some modified examples will be described below.

### First Modified Example

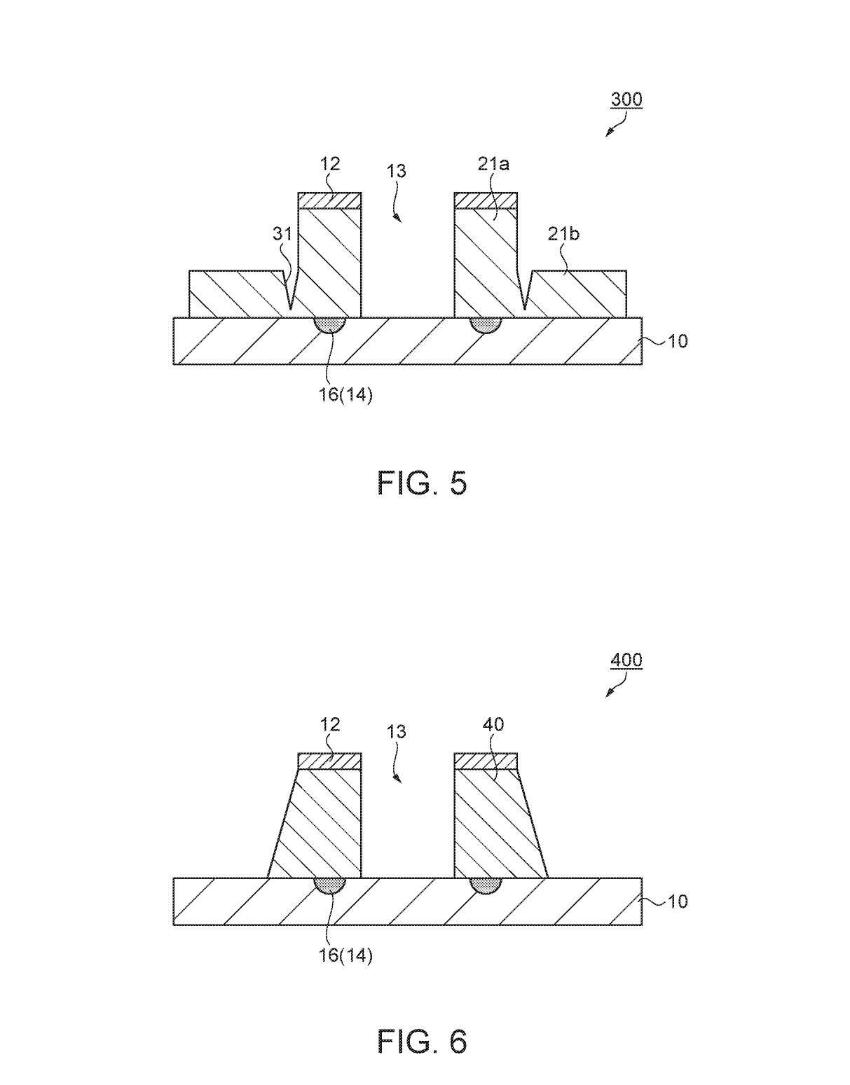

Then, a configuration of a light modulator 300 according to a first modified example will be described with reference to FIG. 5.

FIG. 5 is a cross-sectional view of an essential part of the light modulator 300 according to the first modified example.

The light modulator 300 according to the present modified example has notches 31 on the opposite side to the surfaces of the buffer layer 21b on which the pair of electrodes 12 are opposed to each other. The notches 31 can reach, or fail to reach the element substrate 10. The notches 31 are each formed to have a stepped shape using a usual measure such as photolithography or argon ion etching.

As described hereinabove, according to the light modulator 300 related to the present modified example, the following advantages can be obtained in addition to the advantages in the second embodiment.

Due to the configuration in which the buffer layer 21b is provided with the notches 31, the electric field component in the buffer layer 21b exerted in an outward direction is further suppressed compared to the light modulator 200 according to the second embodiment. Therefore, since the electric field limited to the perpendicular direction reaches the element substrate 10, the variation of the refractive index becomes greater than that of the light modulator 200 according to the second embodiment, and even if the length of the straight parts 16 is decreased, the desired phase shift amount can be provided to the light waves in the multiplexing part 17. Therefore, the light modulator 100 can further be miniaturized.

### Second Modified Example

Then, a configuration of a light modulator 400 according to a second modified example will be described with reference to FIG. 6.

FIG. 6 is a cross-sectional view of an essential part of the light modulator 400 according to the second modified example.

In the light modulator 400 according to the present modified example, the buffer layer 40 is provided with a mesa shape. The buffer layer 40 having the mesa shape is formed using a usual measure such as photolithography or argon ion etching.

As described hereinabove, according to the light modulator 400 related to the present modified example, the following advantages can be obtained in addition to the advantages in the first modified example.

Since the buffer layer 40 has the mesa shape, the electric field component in the buffer layer 40 exerted in the outward direction almost vanishes. Therefore, since the electric field limited to the perpendicular direction reaches the element substrate 10, the variation of the refractive index becomes greater than that of the light modulator 300 according to the first modified example, and even if the length of the straight parts 16 is decreased, the desired phase shift amount can be provided to the light waves in the multiplexing part 17. Therefore, the light modulator 100 can further be miniaturized.

### Third Modified Example

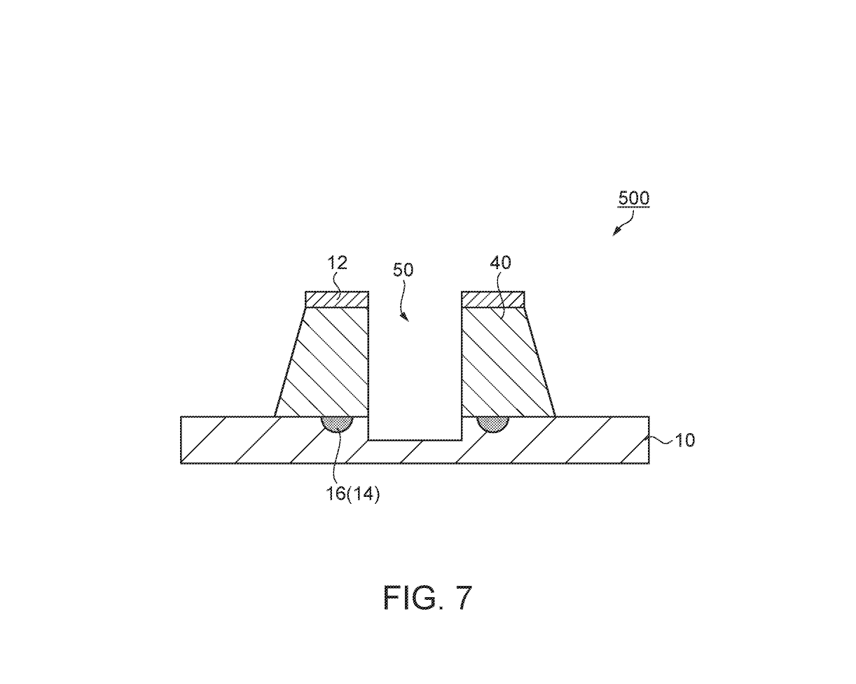

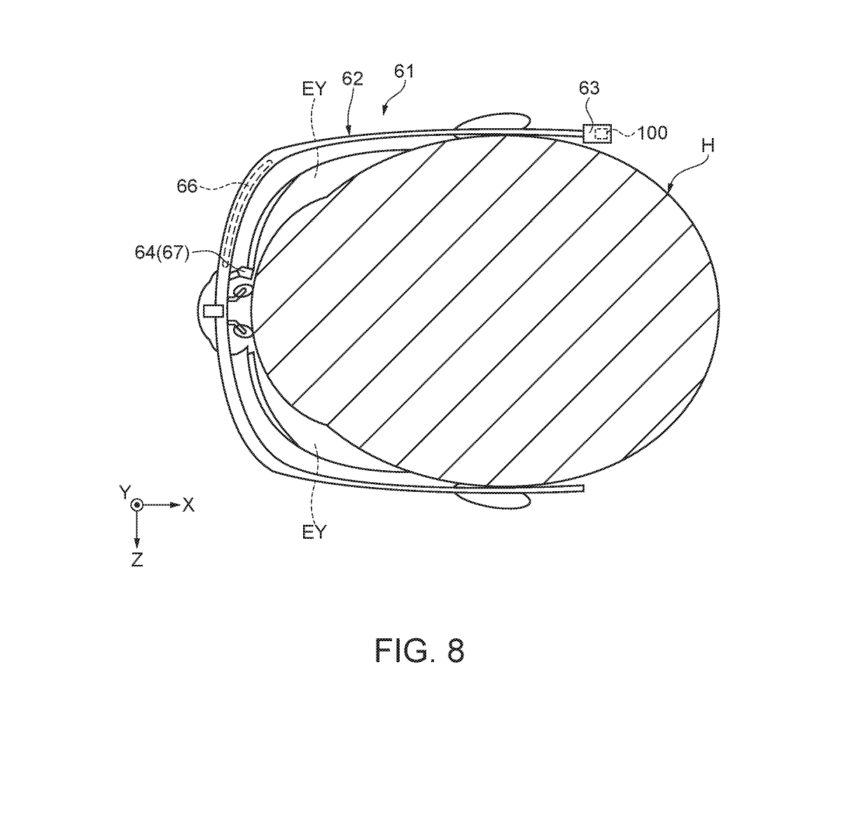

Then, a configuration of a light modulator 500 according to a third modified example will be described with reference to FIG. 7.

FIG. 7 is a cross-sectional view of an essential part of the light modulator 500 according to the third modified example.

In the light modulator 500 according to the present modified example, the groove 50 is formed not only in the buffer layer 40 but also in the element substrate 10. The groove 50 is formed using a usual measure such as photolithography or argon ion etching. The depth of the groove in the element substrate 10 is desirably no smaller than 10 nm and no larger than 100 μm.

As described hereinabove, according to the light modulator 500 related to the present modified example, the following advantages can be obtained in addition to the advantages in the second modified example.

Since the element substrate 10 is provided with the groove 50, the electric field component in the horizontal direction generated in the element field 10 between the electrodes 12 vanishes, and the electric field component in the straight parts 16 is limited to the perpendicular component, and the variation in the refractive index becomes greater than that of the light modulator 400 according to the second modified example. Therefore, even if the length of the straight parts 16 is decreased, the desired phase shift amount can be provided to the light waves in the multiplexing part 17. Therefore, the light modulator 100 can further be miniaturized.

### Image Display Device

### Third Embodiment

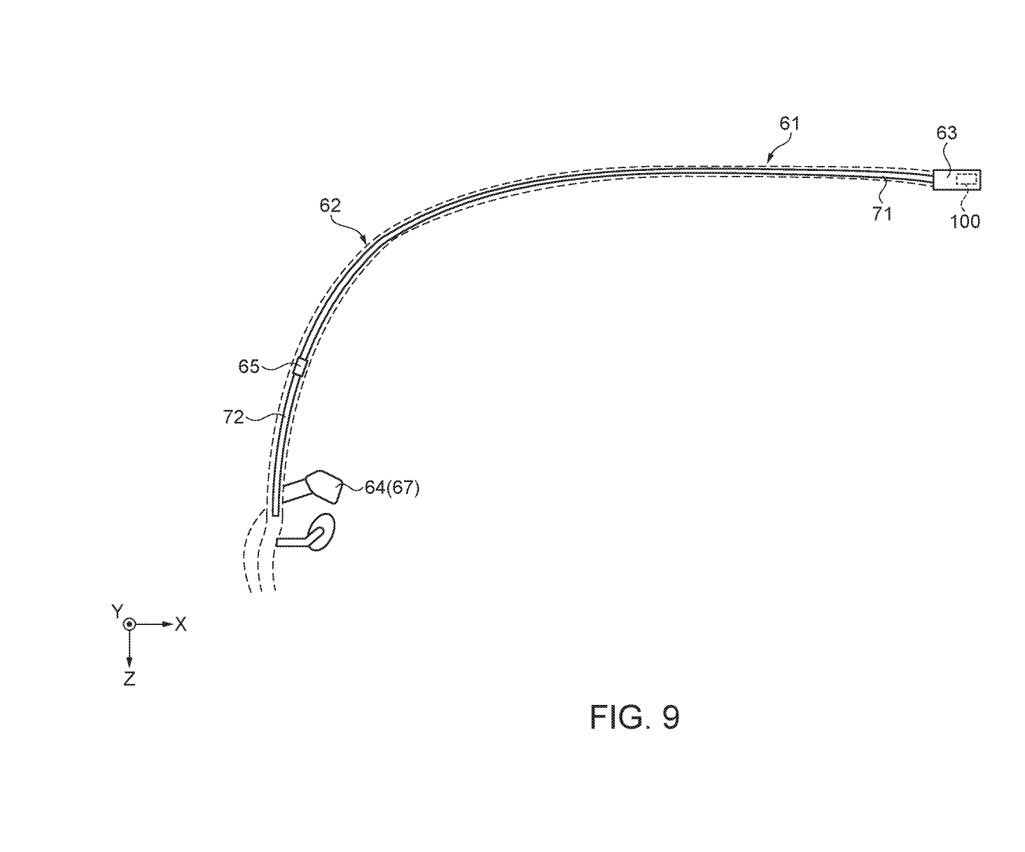

Then, an image display device 61 according to the third embodiment of the invention will be described citing a head-mounted display as an example with reference to FIG. 8 and FIG. 9.

FIG. 8 is a diagram showing a schematic configuration of the image display device 61 (a head-mounted display) according to the third embodiment of the invention. FIG. 9 is a partial enlarged view of the image display device 61 shown in FIG. 8.

It should be noted that in each of FIG. 8 and FIG. 9, an X axis, a Y axis, and a Z axis are illustrated as the three axes perpendicular to each other for the sake of convenience of explanation.

Here, the X axis, the Y axis, and the Z axis are configured so that the Y-axis direction corresponds to a top-to-bottom direction of the head H, the Z-axis direction corresponds to a side-to-side direction of the head H, and the X-axis direction corresponds to a front-to-back direction of the head H when mounting the image display device 61 described later on the head H of the user.

As shown in FIG. 8, the image display device 61 is a head-mounted display (a head-mounted image display device) having an exterior appearance like a pair of spectacles, and is used while being mounted on the head H of the user, and allows the user to visually recognize a virtual image in a state of overlapping the external image.

As shown in FIG. 8, the image display device 61 is provided with a frame 62, a signal generation section 63, a scan light emitting section 64, and a reflecting section 66. It should be noted that the signal generation section 63 incorporates a light source section (not shown) and the light modulator 100, and modulates the signal light, which is emitted from the light source section, using the light modulator 100 in accordance with the image information. Further, the scan light emitting section 64 incorporates a light scanner 67 capable of oscillating around two axes, and emits the scan light to perform two-dimensional scanning operation. As shown in FIG. 9, the image display device 61 is provided with a first optical fiber 71, a second optical fiber 72, and a connection section 65.

In this image display device 61, a signal light emitted from the light source section is modulated in accordance with the image information using the light modulator 100 to thereby generate the signal light modulated. The signal light is guided to the scan light emitting section 64 via the first optical fiber 71, the connection section 65, and the second optical fiber 72. Then, the scan light emitting section 64 performs the two-dimensional scanning operation with the signal light (picture light) to emit the scan light, and the reflecting section 66 reflects the scan light toward the eyes EY of the user. Thus, it is possible to allow the user to visually recognize a virtual image corresponding to the image information.

The entire disclosure of Japanese Patent Application No. 2016-054952, filed Mar. 18, 2016 is expressly incorporated by reference herein.

What is claimed is:

1. A light modulator comprising:
an optical waveguide formed of a material having an electro-optic effect;
a buffer layer formed on the optical waveguide; and
a pair of electrodes formed on the buffer layer,
wherein a width in a direction, in which the pair of electrodes are opposed to each other, of the buffer layer located on a side of the electrodes opposed to the optical waveguide is smaller than a width in the direction, in which the pair of electrodes are opposed to each other, of the buffer layer located on the optical waveguide side.

2. The light modulator according to claim 1, wherein
the width in the direction, in which the pair of electrodes are opposed to each other, of the buffer layer located on the side of the electrodes opposed to the optical waveguide is equal to a width in the direction, in which the pair of electrodes are opposed to each other, of the electrodes.

3. The light modulator according to claim 1, wherein
the buffer layer is provided with a groove disposed between the pair of electrodes.

4. The light modulator according to claim 1, wherein
the buffer layer is provided with a notch disposed on an opposite side to surfaces on which the electrodes are opposed to each other.

5. The light modulator according to claim 1, wherein
the buffer layer is provided with a mesa shape.

6. The light modulator according to claim 3, wherein
the optical waveguide is provided to a substrate, and the groove is provided to the substrate.

7. The light modulator according to claim 1, wherein
the material having the electro-optic effect is lithium niobate.

8. An image display device comprising:
a light source section adapted to emit light;
the light modulator according to claim 1; and
a light scanner adapted to perform a spatial scanning operation with light modulated by the light modulator.

9. An image display device comprising:
a light source section adapted to emit light;
the light modulator according to claim 2; and
a light scanner adapted to perform a spatial scanning operation with light modulated by the light modulator.

10. An image display device comprising:
a light source section adapted to emit light;
the light modulator according to claim 3; and
a light scanner adapted to perform a spatial scanning operation with light modulated by the light modulator.

11. An image display device comprising:
a light source section adapted to emit light;
the light modulator according to claim 4; and
a light scanner adapted to perform a spatial scanning operation with light modulated by the light modulator.

12. An image display device comprising:
a light source section adapted to emit light;
the light modulator according to claim 5; and
a light scanner adapted to perform a spatial scanning operation with light modulated by the light modulator.

13. An image display device comprising:
a light source section adapted to emit light;
the light modulator according to claim 6; and
a light scanner adapted to perform a spatial scanning operation with light modulated by the light modulator.

14. An image display device comprising:
a light source section adapted to emit light;
the light modulator according to claim 7; and
a light scanner adapted to perform a spatial scanning operation with light modulated by the light modulator.
